(19) United States
(12) Patent Application Publication
(10) Pub. No.: US 2025/0300537 A1
(43) Pub. Date: Sep. 25, 2025

(54) METHOD FOR PRODUCING AN ELECTRIC MOTOR, DEVICE FOR PRODUCING AN ELECTRIC MOTOR, ELECTRIC MOTOR AND ROTOR

(71) Applicant: Brose Fahrzeugteile SE & Co. Kommanditgesellschaft, Bamberg, Bamberg (DE)

(72) Inventors: David STARK, Würzburg (DE); Christoph HAAS, Poppenhausen (DE)

(21) Appl. No.: 19/233,787

(22) Filed: Jun. 10, 2025

Related U.S. Application Data
(63) Continuation of application No. PCT/EP2023/086974, filed on Dec. 20, 2023.

(30) Foreign Application Priority Data
Dec. 21, 2022 (DE) 10 2022 214 219.5
Feb. 13, 2023 (DE) 10 2023 201 149.2

(51) Int. Cl. H02K 15/40; H02K 1/22; H02K 15/028

(52) U.S. Cl. CPC H02K 15/40; H02K 1/22; H02K 15/028; H02K 2215/00

(57) ABSTRACT

A method produces an electric motor having a motor housing and a stator that has a stator carrier and a number of phase connections. An electronics housing is joined to the motor housing and has a connection side. A substantially pot-shaped rotor bell is produced by way of a deep-drawing process such that a bell base runs oblique to a peripheral bell wall, and that the bell base has a larger wall thickness than the bell wall. The rotor bell and the stator are inserted into a receptacle in the motor housing, wherein the rotor bell and the stator are added into the motor housing by a stamping unit so as to produce an electrical connection between the phase connections and the connection side.

### CROSS-REFERENCE TO RELATED APPLICATION

This application is a continuation, under 35 U.S.C. § 120, of copending International Patent Application PCT/EP2023/086974, filed Dec. 20, 2023, which designated the United States; this application also claims the priority, under 35 U.S.C. § 119, of German Patent Applications DE 10 2022 214 219.5, filed Dec. 21, 2022 and DE 10 2023 201 149.2, filed Feb. 13, 2023; the prior applications are herewith incorporated by reference in their entirety.

### FIELD AND BACKGROUND OF THE INVENTION

The invention relates to a method for producing an electric motor, having a motor housing and a stator that has a stator carrier and that has a number of phase connections, and having an electronics housing that is joined to the motor housing and has a connections side, wherein a substantially pot-shaped rotor bell is produced by way of a deep-drawing process. The invention further relates to a device for carrying out the method, a rotor for an electric motor, and an electric motor.

Rotating or rotationally symmetrical components always have at least a certain unbalance as a rotational body because of manufacture- or design-related tolerances. An unbalance is to be understood here in particular as an asymmetrical mass distribution of the (rotationally symmetrical) rotational body, as a result of which its axis of rotation does not coincide with or correspond to one of its main axes of inertia. When the rotational body rotates, so-called unbalance forces occur as g- or centrifugal forces due to the unbalance, which increase with increasing rotational speed and cause an unround, eccentric rotational movement of the rotational body. This causes undesired vibrations and noise during operation due to the unbalance of the rotating body.

Due to the unbalance, the service life of a product having the component or the rotational body and/or the service life of the bearing rotatably supporting the rotational body can be reduced. Furthermore, especially at high rotational speeds, there is the risk that the component and/or the bearings will be damaged or completely destroyed.

Particularly in the case of electric motors of a motor vehicle, which are arranged, for example, in the region of a passenger compartment, such as, for example, seat adjustment drives or window lifter drives, operation which is as noise-reduced as possible is desired. Furthermore, such electric motors should be as compact as possible in terms of installation space, i.e. have as small an (installation) size as possible. Such electric motors therefore require rotationally symmetrical components, such as, for example, rotors, which have as little unbalance as possible.

In electric motors embodied as external rotors, the rotor can be embodied with a deep-drawn rotor bell as part of the motor housing. In the installed state, the rotor bell here forms, for example, a certain cover to an electronics housing interior space up to the stator.

In this case, the rotor bell is intended to fulfill several functions in the assembled state. On the one hand, the rotor bell is intended to ensure a rigid connection between the rotor and the permanent-magnet rotor magnets, wherein the rotor magnets in this case are arranged distributed, in particular, on an inner circumference of a bell wall of the rotor bell. Furthermore, the rotor bell is intended to realize a rigid and operationally reliable connection to the motor shaft, wherein the rotor bell typically has, in the region of a bell base, a passage opening for the motor shaft and an annular collar surrounding the passage opening for positively and/or non-positively retaining the motor shaft. In addition, the rotor bell is intended to provide an electromagnetic return for the magnetic circuit of the rotor magnets. This is generally effected by the peripheral bell wall which carries the rotor magnets and which acts as a magnetic yoke or return. A further function of the rotor bell to be fulfilled is to maintain a stable air gap between a stator lamination stack and the rotor magnets. In particular, the rotor bell is intended to ensure compliance with certain minimum requirements for the initial unbalance, the ability to balance the unbalance, and good concentricity of the rotor to the stator.

In order to eliminate or correct unbalances, it is possible to balance the rotor bell. In the case of balancing, an asymmetrical mass distribution of the rotor bell is corrected or compensated. This is done, for example, by attaching or applying an additional mass, or by removing or ablating a mass of the rotor bell, for example by means of cutting methods.

The deep-drawn rotor bell has, for example, a closed bell base with the exception of the passage opening, with two additional drawing steps which are intended to improve the rigidity and mechanical stability of the rotor bell. In this case, the bell base has substantially the same wall strength or wall thickness as the bell wall. Since a larger initial unbalance is to be expected due to the inaccuracies expected from the deep-drawing process, this drawing stage design for the unbalance compensation is to be classified as critical.

Furthermore, it is necessary, for example, to join the stator to the electronics housing in the manufacturing process, wherein this is possible only after the rotor bell joining due to the process sequence and the design. However, since access to the stator carrier is not given for this purpose because of the closed bell base, but the stator is to be pressed into the end face of the electronics housing by means of a device, a joining process without recesses on the rotor bell is disadvantageously made more difficult.

### SUMMARY OF THE INVENTION

It is an object of the invention to provide a particularly suitable method for producing an electric motor. In particular, a reliable and simple balancing of a rotor bell is to be made possible. Furthermore, a reliable joining of the stator is to be realized. The invention is also based on the object of indicating a particularly suitable device for carrying out the method, a particularly suitable rotor for an electric motor, and a particularly suitable electric motor.

With the foregoing and other objects in view there is provided, in accordance with the invention, a method for producing an electric motor. The method includes providing a motor housing, providing a stator having a stator carrier and a plurality of phase connections, providing an electronics housing being joined to the motor housing and having a connection side, and producing a substantially pot-shaped rotor bell by way of a deep-drawing process. The substantially pot-shaped rotor bell has a bell base running oblique to a peripheral bell wall, and that the bell base has a larger wall thickness than the bell wall. The substantially pot-shaped rotor bell and the stator are inserted into a receptacle in the motor housing. The substantially pot-shaped rotor bell and the stator are added into the motor housing by a stamping unit so as to produce an electrical connection between the plurality of phase connections and the connection side.

With the foregoing and other objects in view there is provided, in accordance with the invention, a device for producing an electric motor containing a housing having a receptacle, a stator having a stator carrier and a plurality of phase connections, an electronics housing being joined to the motor housing and having a connection side, and a substantially pot-shaped rotor bell having a bell base running oblique to a peripheral bell wall. The bell base has a larger wall thickness than the bell wall. The substantially pot-shaped rotor bell and the stator are disposed in the receptacle in the motor housing. The device comprises a deep-drawing device for producing the substantially pot-shaped rotor bell, and a stamping unit for joining the substantially pot-shaped rotor bell and the stator to the motor housing.

With the foregoing and other objects in view there is provided, in accordance with the invention, a rotor for an electric motor. The rotor contains a substantially pot-shaped rotor bell having a bell base and a peripheral bell wall. The bell base runs oblique to the peripheral bell wall, and the bell base has a larger wall thickness than the peripheral bell wall.

With the foregoing and other objects in view there is provided, in accordance with the invention, an electric motor for a motor vehicle. The electric motor contains a motor housing having a receptacle, a stator having a stator carrier and a plurality of phase connections, an electronics housing joined to the motor housing and having a connection side, and a rotor bell. The rotor bell and the stator are disposed in the receptacle in the motor housing. The rotor bell and the stator are added into the motor housing so as to produce an electrical connection between the plurality of phase connections and the connection side.

Advantageous designs and further developments are the subject matter of the dependent claims.

If method steps are described below, advantageous designs for the device result in particular from the fact that it is formed to execute one or more of these method steps. The advantages and designs cited with respect to the method can also be transferred to the device and/or the rotor and/or the electric motor and vice versa. The conjunction “and/or” is to be understood here and below such that the features linked by means of this conjunction can be formed both jointly and as alternatives to one another.

The method according to the invention is provided for producing an electric motor and is suitable and configured for this purpose. The electric motor is, for example, part of a standard construction kit which can be used for four different adjustment levels as a seat adjustment drive or also as a window lifter drive. The electric motor, which is in particular brushless, has a stator as an electric (three-phase) machine which is provided with a field or stator winding and which is arranged coaxially with a rotor with one or more permanent magnets. The stator is constructed, for example, as a lamination stack, wherein stator teeth carry the coils of the stator winding in stator grooves located therebetween.

The alternating current provided for supplying the electric motor or the stator winding is generated, for example, by a converter (inverter). This converter, together with an associated control electronics, is accommodated in an electronics housing which is joined to a motor housing accommodating the rotor and stator.

The stator has a stator carrier carrying the lamination stack for mounting in the motor housing. Furthermore, the stator or the stator winding has a number of phase terminals which are to be connected or contacted to a terminal side of the electronics housing for contacting with the converter.

The electric motor is embodied in particular as an external rotor, wherein the (external) rotor has a rotor bell, which is equipped with rotor magnets, as a pole pot (rotor pot) and which, in the assembled state, forms in sections a part of the motor housing, in particular a housing section surrounding the stator.

“Axial” or an “axial direction” is understood here and hereinafter in particular to mean a direction parallel (coaxial) to the axis of rotation of the electric motor, i.e. perpendicular to the end faces of the stator. Correspondingly, “radial” or a “radial direction” is understood here and hereinafter to mean, in particular, a direction oriented perpendicularly (transversely) to the axis of rotation of the electric motor along a radius of the stator or of the electric motor. “Tangential” or a “tangential direction” is understood here and hereinafter in particular to mean a direction along the circumference of the stator or of the electric motor (circumferential direction, azimuthal direction), i.e. a direction perpendicular to the axial direction and to the radial direction.

According to the method, a substantially pot-shaped rotor bell is produced by way of a deep-drawing process such that a bell base runs oblique to a peripheral bell wall, and that the bell base has a larger wall thickness than the bell wall. Preferably, for the deep-drawing process, a sheet metal with a sheet metal strength is used which substantially corresponds to the wall thickness of the later bell base, wherein the sheet metal is drawn deeper or thinned out in the region of the bell wall.

An oblique alignment or orientation of the bell base is to be understood here as an inclined arrangement to the bell wall. An angle of inclination to the bell base, measured starting from the bell wall, is dimensioned to be obtuse here, i.e. larger than 90°, for example between 95° and 130°, in particular between 100° and 105°, preferably about 103.5°. The bell base has a central passage opening for a motor shaft. The bell base thus has a funnel-shaped or frustoconical course from the passage opening to the bell wall. The passage opening is surrounded by an annular collar which projects beyond the inside of the bell base. In the assembled state, the annular collar is joined to the motor shaft in a manner fixed to the shaft.

The rotor bell is equipped, for example, with a number of permanent magnet rotor magnets for forming the rotor. In this case, the rotor magnets are arranged distributed and fastened to an inner wall or inner surface of the bell wall.

In a subsequent method step, the rotor bell and the stator are inserted into a receptacle in the motor housing. Afterwards, the rotor bell and the stator are added, in particular pressed, into the motor housing by a stamping unit so as to produce an electrical connection between the phase connections and the connection side, so that a reliable joining operation of the stator to the electronics housing is realized. Thus, a particularly suitable method for producing the electric motor is realized.

According to the invention, the drawing steps for the bell base are thus omitted in the design of the rotor bell. The bell base therefore has no further drawing steps. According to the invention, the drawing stages are replaced by an oblique rear wall. In the joined state, the oblique course of the bell base realizes sufficient installation space for a winding head of the stator or of the stator winding, so that an electric motor with a particularly compact installation space is produced.

The thickening of the bell base ensures the necessary stiffness and mechanical stability of the rotor bell. Furthermore, the thickening of the bell base simultaneously realizes a defined “balancing plane” for balancing out unbalances, which, compared to a rotor bell with drawing steps, permits wider and deeper milling of the material for the balancing process, as a result of which a larger unbalance budget for, in particular negative, unbalance compensation is realized.

In an advantageous further development, a negative unbalance compensation is carried out on the bell base as part of the production. For example, the unbalance of the rotor bell is reduced by a cutting method in which material is removed or ablated from the bell base. Alternatively, for example, laser abrasion or laser ablation to compensate for unbalance is also conceivable. Preferably, the unbalance compensation is carried out after the rotor magnets have been fixed and before the joining process.

In an expedient design, the deep-drawing process is carried out such that the bell base has a wall thickness which is between 40% and 60%, in particular between 40% and 50% larger than the bell wall. For example, the bell base has a wall thickness of about 2 mm (millimeters) and the bell wall has a wall thickness of about 1.2 mm (millimeters). In the course of a negative balance compensation, the wall thickness of the bell base is locally reduced to, for example, approximately 0.5 mm.

An additional or further aspect of the invention provides that at least one hole-like recess is introduced into the bell base. Preferably, a number of recesses, i.e. at least two recesses, preferably three recesses, are introduced into the bell base. The recesses are arranged, for example, tangentially distributed radially outside the central passage opening. The recesses are introduced into the bell base by punching, for example. The recesses are preferably introduced after the deep-drawing process, so that the positioning is ensured without risk of distortion.

The stamping unit suitably has at least one stamping extension. Expediently, the stamping unit has a number of stamping extensions corresponding to the number of recesses. The number of recesses and the number of stamping extensions are thus complementary. In the course of the joining process, the at least one recess is passed through by the at least one stamping extension such that the stamping extension comes to bear directly against an end face of the stator carrier. The stamping unit thus bears directly, i.e. straight, against the stator carrier through the recess. This ensures a particularly reliable and process-reliable joining process of the stator to the electronics housing.

For example, three holes with a bean-shaped cross-sectional shape, for example, are introduced into the bell base, through which the stamping extensions for joining the stator can penetrate in the process in order to be able to press onto the stator or the stator carrier, and thus press the stator into the electronics housing in a process-reliable manner, so that the phase connections are reliably contacted with the connection side.

The device according to the invention is provided for carrying out a method described above and is suitable and set up for this purpose. The device has a deep-drawing device for producing a rotor bell, and a stamping unit for adding the rotor bell and the stator into the motor housing. Thus, an advantageous device for producing an electric motor is realized.

In an advantageous embodiment, the stamping unit has an end-side contact surface for the bell base and at least one stamping extension axially projecting upwards from the contact surface for passing through a recess in the rotor bell and for directly bearing against an end face of a stator carrier of the stator. As a result, a particularly advantageous stamping unit for joining the rotor, stator, and motor housing is realized.

In a suitable further development, the stamping unit has a circular cylindrical joining stamp for joining. Preferably, the contact surface and the at least one stamping extension are arranged on an end face of the joining stamp. In this case, the joining stamp has a cylindrical sector-shaped receptacle, extending along the axial direction (longitudinal direction of the joining stamp) for a motor shaft of the electric motor. By means of the receptacle, the motor shaft, which is equipped, for example, with further components (for example a worm shaft of a worm gear), can be inserted radially into the joining stamp, so that the components of the motor shaft and the rotor bell are arranged on the opposite sides of the contact surface. As part of the joining process (pressing process), the receptacle ensures that no undesired forces act on the motor shaft or on components fixed thereto.

In a preferred design, the stamping unit has a stamping collar surrounding the joining stamp and at least partially enclosing the motor housing during the joining process. The motor housing is therefore preferably held radially in a form-fitting manner in the stamping collar. This ensures a particularly high joining or pressing accuracy during a stamping movement for adding the rotor and the stator into the motor housing.

The rotor according to the invention is provided for an electric motor, for example for a seat adjustment drive or a window lifter drive, and is suitable and set up for this purpose. The rotor is preferably produced in the context of the method described above and has a substantially pot-shaped rotor bell that has a bell base and that has a peripheral bell wall, wherein the bell base runs oblique to the bell wall, and wherein the bell base has a larger wall thickness than the bell wall. Thus, a particularly suitable rotor for the electric motor is realized. The bell base has no additional drawing steps and, due to the increased wall strength or wall thickness, permits a particularly high unbalance budget for a negative unbalance compensation, so that a particularly smooth electric motor operation is made possible with the rotor.

The electric motor according to the invention is provided for a motor vehicle, in particular for a seat adjustment drive or a window lifter drive, and is suitable and set up for this purpose. The electric motor is preferably produced according to the method described above.

The electric motor has a stator and a rotor, which are accommodated in a motor housing. An electronics housing accommodating the electronics of the electric motor is joined to the motor housing. The electronics housing has a connection side for contacting and wiring a number of phase connections. The stator has a stator winding which ends in the phase connections. The stator winding is applied, for example, to a stator lamination stack, wherein the lamination stack is held by means of a stator carrier. The rotor has a rotor bell as a pole pot, which is equipped on the inside with permanent magnet rotor magnets.

The rotor or the rotor bell and the stator are inserted into a receptacle in the motor housing and are added into the motor housing so as to produce an electrical connection between the phase connections of the stator and the connection side of the electronics housing. Thus, a particularly suitable electric motor is realized.

Other features which are considered as characteristic for the invention are set forth in the appended claims.

Although the invention is illustrated and described herein as embodied in a method for producing an electric motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, sectional view of an electric motor having a motor housing, an electronics housing, a stator, and a rotor;

FIG. 2 is a perspective view a rotor bell of the rotor;

FIG. 3 is a sectional view the rotor bell;

FIG. 4 is a perspective view of a stamping unit for adding the rotor and the stator into the motor housing;

FIG. 5 is a perspective view of a joining operation; and

FIG. 6 is a sectional view of the stamping unit and the electric motor during the joining operation.

Parts and sizes corresponding to one another are always provided with the same reference numerals in all figures.

### DETAILED DESCRIPTION OF THE INVENTION

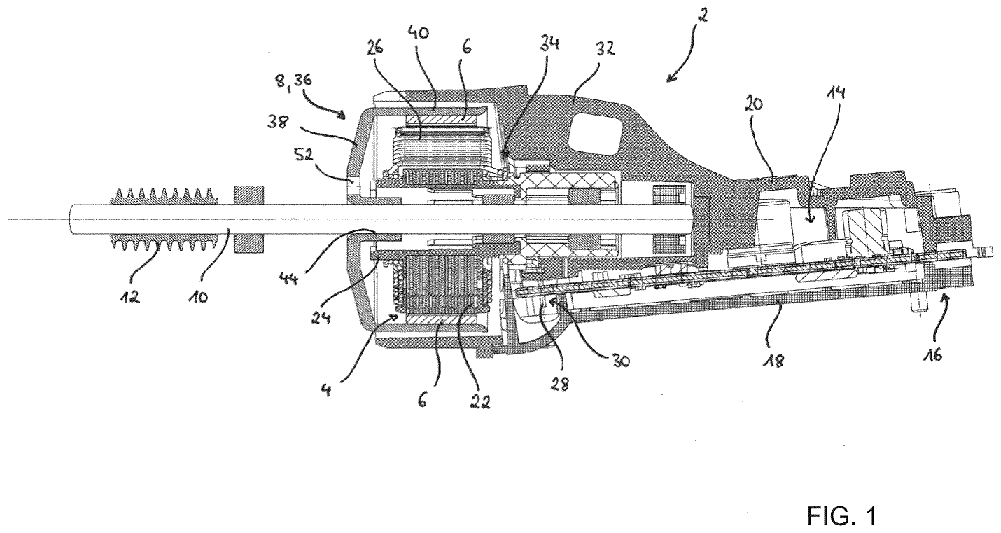

Referring now to the figures of the drawings in detail and first, particularly to FIG. 1 thereof, there is shown an electric motor 2 as an adjusting or drive motor, which is used, for example, for a seat longitudinal adjustment of a motor vehicle seat.

The electric motor 2 is embodied as a brushless external rotor with a wound stator 4 and a rotor 8 provided with permanent magnet rotor magnets 6. The rotor 8 is joined to a rotatably mounted motor shaft 10 in a manner fixed to the shaft. A helical worm shaft 12 for driving a gear wheel, not shown in detail, is arranged on the motor shaft 10.

The electric motor 2 is connected to a (motor) electronics 14 which is arranged in an electronics housing 16. The electronics housing 16 has an electronic carrier 18 and an electronic lid 20. The electronics housing 16 is arranged on an end face of the electric motor 2 opposite the worm shaft 12.

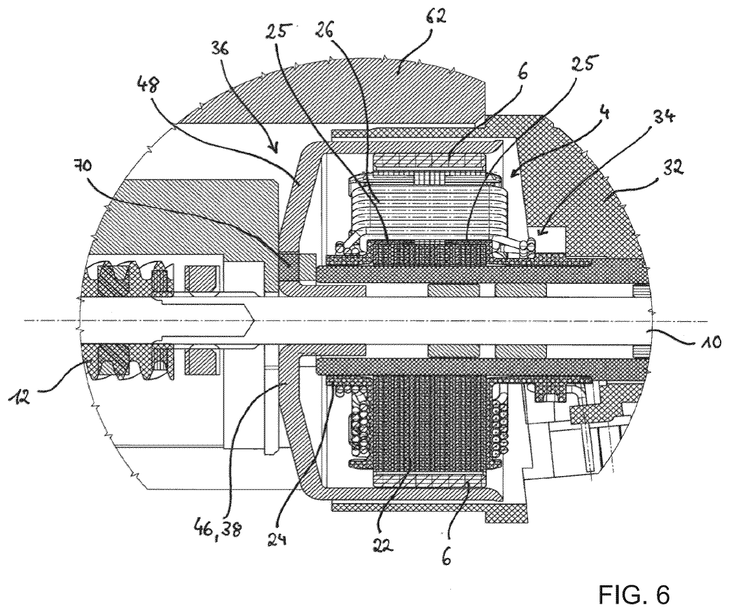

The stator 4 has a (stator) lamination stack 22 with a central passage opening, in which a sleeve-shaped or tubular stator carrier 24 is inserted. Two interconnection rings (contact units) 25 for guiding and wiring coil wires of a stator winding 26, for example, are placed on the opposite end faces of the lamination stack 22. The interconnection rings 25 and the stator carrier 24 can, however, also be designed as a common component, for example as an injection molding of the lamination stack 22. FIG. 6 shows a separate embodiment of the interconnection rings 25 and the stator carrier 24, wherein FIG. 1 in particular shows a one-piece embodiment as an injection molding. The stator carrier 24 is made of an electrically non-conductive, mechanically stable plastic material.

A multiphase rotary field winding is applied as the stator winding 26 to the lamination stack 22 or to the stator carrier 24. The winding or coil ends are guided as phase connections 28 in the direction of a connection side 30 of the electronics housing 16.

The stator 4 and the rotor 8 are seated in a motor housing 32 which is connected or joined to the electronics housing 16 and which encloses the rotor 8 on the outer circumference. In this case, the stator 4 and the rotor 8 are inserted into a receptacle 34. In the inserted state, the stator carrier 24 holds the stator 4 fixed to the housing with respect to the motor housing 32, wherein the phase connections 38 are connected to the connection side 30, for example by means of (cutting) clamping contacts, to the electronics 14.

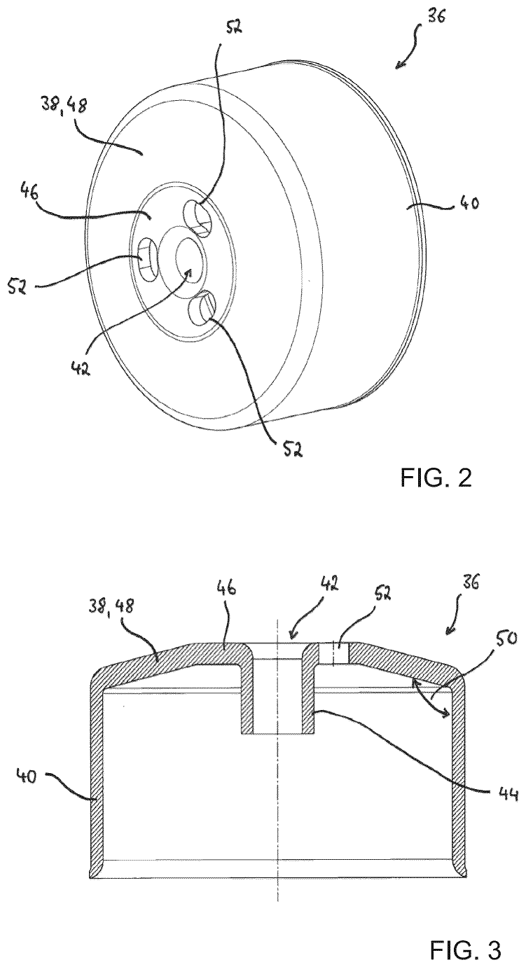

The construction of the (external) rotor 8 is explained in more detail below with reference to FIGS. 2 and 3.

The rotor 8 has a rotor bell (rotor pot, pole pot) 36. The rotor bell 36 substantially has a bell base 38 and a peripheral bell wall 40.

The bell wall 40 is a hollow cylindrical or tubular annular wall which, in the assembled state, encloses the outer circumference of the stator 4 and wherein on the inner side or inner surface thereof the rotor magnets 6 are arranged.

The bell base 38 has a central passage opening 42 for receiving the motor shaft 10. The passage opening 42 is surrounded by an inwardly projecting annular collar 44 which forms the mechanical interface for fastening the motor shaft 10.

The bell base 38 has an approximately annular rotor hub 46 which has the passage opening 42 and the annular collar 44 and which is arranged substantially perpendicularly to the bell wall 40. The bell base 38 further has a base section 48 which connects the rotor hub 46 to the bell wall 40 and which is oriented oblique to the rotor hub 46 and the bell wall 40. The approximately funnel-shaped or frustoconical base section 48 has no further drawing steps. An angle of inclination 50 between the base section 48 and the bell wall 40 is embodied as an obtuse angle larger than 90°. For example, the angle of inclination is dimensioned between 100° and 110°, for example to about 105°, preferably to 103.5°.

The rotor bell 36 is produced as a deep-drawn part and is deep-drawn in the course of production such that the bell base 38 is oblique and that the bell base 38 has a larger wall strength or wall thickness than the bell wall 40. In an expedient design, the deep-drawing process is carried out such that the bell base 38 has a wall thickness which is between 40% and 60% larger than the bell wall 40. In the exemplary embodiment shown, the bell base 38 has a wall thickness which is about 50% larger than the bell wall 40. Preferably, in the course of the production or assembly of the electric motor 2, a negative unbalance compensation is carried out on the bell base 38 of the rotor 8.

In the region of the rotor hub 46, three oval or bean-shaped recesses 52 are arranged distributed tangentially around the passage opening 42. The hole-like recesses 52 are introduced, for example, by means of punching before or after the deep-drawing process.

For the production of the electric motor 2, a rotor bell 36 as described above is produced by way of a deep-drawing process by means of a deep-drawing device not shown in more detail. The rotor bell 36 or the rotor 8 is inserted together with the stator 4 into the receptacle 34 in the motor housing 32 and is subsequently added, in particular pressed, into the motor housing by a stamping unit 54. In this case, an electrical connection is caused between the phase connections 28 and the connection side 30 of the electronics housing 16.

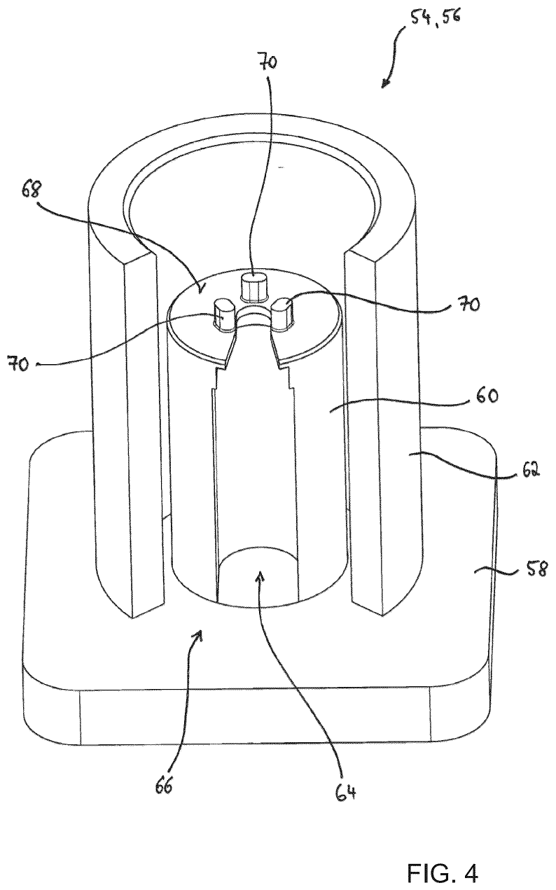

The joining process is explained in more detail below with reference to FIGS. 4 to 6.

FIG. 4 shows a movable stamping head 56 of the stamping unit 54 for adding or pressing the rotor 8 and the stator 4 into the motor housing 32. The stamping head 56 can be moved, for example, by an electric motor, hydraulically, or pneumatically in order to execute the joining or pressing operation.

The stamping head 56 has a stamping plate 58 on which a vertically upwardly projecting joining stamp 60 is integrally formed. The joining stamp 60 is surrounded by an annular stamping collar 62. The joining stamp 60 is embodied to be substantially cylindrical, wherein the coaxially arranged stamping collar 62 is embodied to be substantially hollow cylindrical.

The joining stamp 60 and the stamping collar 62 are opened on one side. The joining stamp 60 has a recess in the form of a cylindrical sector as a receptacle 64 which is arranged in radial alignment with a corresponding recess 66 of the stamping collar 62. The receptacle 64 and the recess 66 each extend over the complete (axial) length or height of the joining stamp 60 or of the stamping collar 62

The joining stamp 60 has an end-side contact surface 68 for the bell base 38, in particular for the rotor hub 46. Three integrally formed stamping extensions 70 projecting axially upwards are integrally formed on the contact surface 68. The stamping extensions 70 have a cross-sectional shape which is embodied to be complementary to the cross-sectional shape of the recesses 52. The stamping extensions 70 have an axial height which is larger than the wall thickness of the bell base 38. The stamping extensions 70 are provided and set up to pass through the recesses 52 during the joining or pressing process and to come to bear directly against an end face of the stator carrier 24 (FIG. 6).

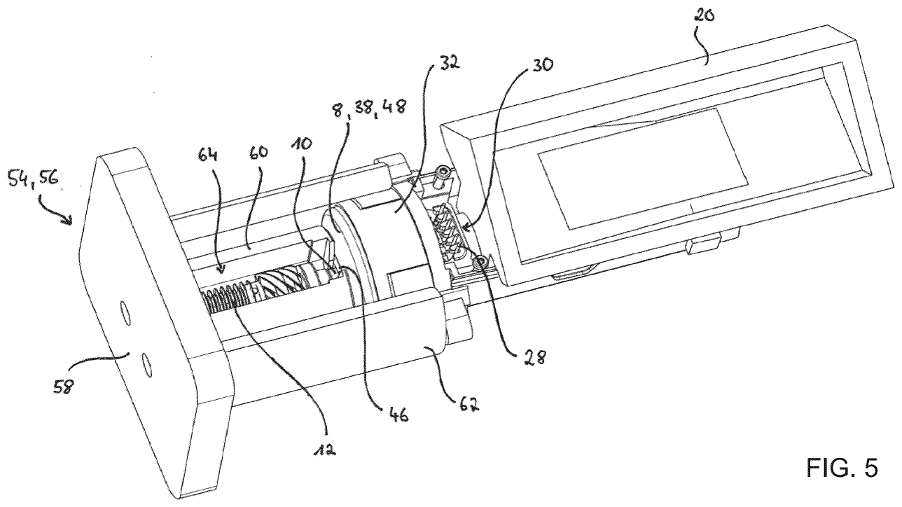

In order to produce the electric motor 2, the stator 4, the rotor 8, and the motor shaft 10 are inserted into the motor housing 32. Subsequently, the preassembled electric motor 2 is inserted radially via the recess 66 into the receptacle 64 such that the motor housing 32 is partially enclosed radially in a form-fitting manner by the stamping collar 62, and the recesses 52 are arranged opposite to the associated stamping extensions 70. As can be seen, for example, in FIG. 5, the motor shaft 10 is seated in the receptacle 64 together with the worm shaft 12.

Subsequently, the stamping unit 54 is actuated and the stamping head 56 is moved linearly in the axial direction onto the motor housing 32. As a result, the contact surface 68 first comes into contact with the rotor hub 46 and presses the rotor 8 in the direction of the receptacle 34. In this case, the stamping extensions 70 come into contact with the stator carrier 24, as a result of which the stator 4 is reliably pressed into the motor housing 32 or the receptacle 34. The stamping head 56 thus rests straight or directly on the rotor 8 as well as on the stator 4 during the joining process, so that a reliable and secure pressing into the motor housing 32 is realized. In this case, the phase connections 28 are wired or contacted with the connection side 30.

The claimed invention is not limited to the exemplary embodiments described above. Rather, other variants of the invention can also be derived therefrom by the skilled person within the scope of the disclosed claims, without departing from the subject matter of the claimed invention. In particular, all the individual features described in connection with the various exemplary embodiments can also be combined in another way within the scope of the disclosed claims without departing from the subject matter of the claimed invention.

The following is a summary list of reference numerals and the corresponding structure used in the above description of the invention:
2 electric motor
4 stator
6 rotor magnet
8 Rotor
10 motor shaft
12 worm shaft
14 electronics
16 electronics housing
18 electronic carrier
20 electronic lid
22 lamination stack
24 stator carrier
25 interconnection ring
26 stator winding
28 phase connection
30 connection side
32 motor housing
34 receptacle
36 rotor bell
38 bell base
40 bell wall
42 passage opening
44 ring collar
46 rotor hub
48 base section
50 angle of inclination
52 recess
54 stamping unit
56 stamping head
58 stamping plate
60 joining stamp
62 stamping collar
64 receptacle
66 recess
68 contact surface
70 stamping extension

1. A method for producing an electric motor, which comprises the steps of:
providing a motor housing;
providing a stator having a stator carrier and a plurality of phase connections;
providing an electronics housing being joined to the motor housing and having a connection side;
producing a substantially pot-shaped rotor bell by way of a deep-drawing process, said substantially pot-shaped rotor bell having a bell base running oblique to a peripheral bell wall, and that the bell base having a larger wall thickness than the bell wall; and
inserting the substantially pot-shaped rotor bell and the stator into a receptacle in the motor housing, wherein the substantially pot-shaped rotor bell and the stator are added into the motor housing by a stamping unit so as to produce an electrical connection between the plurality of phase connections and the connection side.

2. The method according to claim 1, which further comprises carrying out a negative unbalance compensation on the bell base.

3. The method according to claim 1, which further comprises carrying out the deep-drawing process such that the wall thickness of the bell base is between 40% and 60% larger than the bell wall.

4. The method according to claim 1, which further comprises introducing at least one recess into the bell base, wherein the stamping unit has at least one stamping extension which, during joining, passes through the recess and comes to bear directly against an end face of the stator carrier.

5. A device for producing an electric motor containing a motor housing having a receptacle, a stator having a stator carrier and a plurality of phase connections, an electronics housing being joined to the motor housing and having a connection side, and a substantially pot-shaped rotor bell having a bell base running oblique to a peripheral bell wall, the bell base having a larger wall thickness than the bell wall, the substantially pot-shaped rotor bell and the stator are disposed in the receptacle in the motor housing, the device comprising:
a deep-drawing device for producing the substantially pot-shaped rotor bell; and
a stamping unit for joining the substantially pot-shaped rotor bell and the stator to the motor housing.

6. The device according to claim 5, wherein said stamping unit has an end-side contact surface for the bell base and at least one stamping extension which projects axially upwards from said end-side contact surface in order to pass through a recess of the substantially pot-shaped rotor bell and to bear directly against an end face of the stator carrier.

7. The device according to claim 5, wherein said stamping unit has a circular cylindrical joining stamp for joining, said circular cylindrical joining stamp has a cylinder sector-shaped receptacle for a motor shaft extending along an axial direction.

8. The device according to claim 7, wherein said stamping unit has a stamping collar surrounding said circular cylindrical joining stamp and at least partially enclosing the motor housing during a joining process.

9. A rotor for an electric motor, the rotor comprising:
a substantially pot-shaped rotor bell having a bell base and a peripheral bell wall, said bell base running oblique to said peripheral bell wall, and said bell base having a larger wall thickness than said peripheral bell wall.

10. An electric motor for a motor vehicle, comprising:
a motor housing having a receptacle;
a stator having a stator carrier and a plurality of phase connections;
an electronics housing joined to said motor housing and having a connection side; and
a rotor bell, said rotor bell and said stator are disposed in said receptacle in said motor housing, wherein said rotor bell and said stator are added into said motor housing so as to produce an electrical connection between said plurality of phase connections and said connection side.
